(19) United States
(12) Patent Application Publication
(10) Pub. No.: US 2011/0081791 A1
(43) Pub. Date: Apr. 7, 2011

(54) CONNECTOR FOR FLEXIBLE CABLE

(75) Inventor: YongSoo Kim, Gyeonggi-do (KR)

(73) Assignee: MOLEX INCORPORATED, Lisle, IL (US)

(21) Appl. No.: 12/994,994

(22) PCT Filed: May 28, 2009
(86) PCT No.: PCT/IB2009/006967

§ 371 Date: Nov. 29, 2010

(30) Foreign Application Priority Data
May 28, 2008 (KR) 10-2008-0049908

(51) Int. Cl. H01R 12/77

(52) U.S. Cl. 439/62; 439/81

(57) ABSTRACT

A connector for a flexible cable is provided. Connection parts of an even terminal and an odd terminal alternately cross each other to align a rotation center with the center of an X-shape. Operation parts of the terminals are divided into rotation start sections and rotation end sections. Recesses of the rotation start sections are deeper than recesses of the rotation end sections. A stopper prevents reduction of a contact pressure after a rotator engages with the rotation end sections at an angle of 90°.

### BACKGROUND OF THE DISCLOSURE

1. Field of the Disclosure

The Present Disclosure relates to a connector for a flexible cable, and more particularly, to a back flip-type connector for a flexible cable, in which connection parts of an even terminal and an odd terminal cross each other to improve reliability of contacts between a flexible printed circuit/flexible flat cable and the terminals and to maintain maximum contact pressure.

2. Description of the Related Art

Flexible cables include so-called flexible printed circuits (FPCs) and flexible flat cables (FFCs) in the Present Disclosure, and a contact pressure is a pressure at a point where a pressing protrusion and a contact protrusion of a terminal are in contact with an FPC/FFC.

In a related art connector for a flexible cable, an actuator provided with a rotator is disposed on the front side of the connector along the direction in which an FPC/FFC is inserted. However, more recently, a back flip-type connector is widely used in which a rotator of a connector is rotated reversely to a forward rotation according to the related art, so as to reduce the thickness of the connector and to improve workability.

Particularly, such a back flip-type connector employs an H-beam shaped terminal to reduce product thickness so that a mechanism driving a contact is simple and the terminal can be efficiently moved up and down by the operation of a rotator. Thus, back flip-type connectors having H-beam shaped terminals are generally used. FIGS. 1A-C include a cross-sectional view illustrating back flip-type connector 1 and a schematic view and graph illustrating a contact pressure according to the rotation of actuator 10, according to the related art. Connector 1 includes housing 12, terminal 11 inserted into housing 12 to electrically connect to FPC/FFC 15, and actuator 10 which engages terminal 11 and rotates to bring terminal 11 into contact with FPC/FFC 15. When actuator 10 rotates in the direction of the arrow, operation part 13, engaged with actuator 10, is lifted. Thus, pressing part 14, disposed on the rear side to connect to operation part 13, is pressed downward and contacts FPC/FFC 15 inserted into housing 12.

To increase the contact pressure between FPC/FFC 15 and pressing part 11 when actuator 10 rotates, rotatable rotation part 10a is divided into three surfaces—L1, L2 and L3. The distances between the center of actuator 10 and surfaces L1, L2 and L3 satisfy L1<L2<L3.

When actuator 10 rotates from an open state to a closed state in the direction of the arrow, surface L1 is first brought in contact with housing 12. When actuator 10 further rotates continuously to arrive at surface L2 through surface L3, actuator 10 is stopped to bring pressing part 14 in contact with FPC/FFC 15. However, since the contact pressure between FPC/FFC 15 and pressing part 14 is highest at surface L3, where actuator 10 is rotated, and not at surface L2 where actuator 10 is stopped, there is a limitation that the contact pressure is decreased at surface L2 where actuator 10 is stopped. Thus, it is difficult to firmly connect FPC/FFC 15 to terminal 11 of connector 1, and contact reliability is decreased.

In addition, when actuator 10 rotates, the entire surface from surface L1 to surface L3 is in contact with operation part 13 of terminal 11 and housing 12. Thus, when actuator 10 rotates, actuator 10 presses housing 12 sequentially along surfaces L1 to L3, and housing 12 and operation part 13 apply force opposite to that lifting operation part 13 to actuator 10. Accordingly, the frictional force with housing 12 and operation part 13 is increased, and a large force is required to rotate actuator 10. Currently, a connector applied to large-sized displays (e.g., flat panel displays) includes approximately 50-200 pins, and a large-sized liquid crystal display TV includes approximately 6-8 connectors, each of which includes 128 or more pins. It becomes necessary to rotate many actuators with a large force in a manufacturing process used to normally manufacture hundreds of products a day, reducing workability and work load.

FIGS. 2A-2B are cross-sectional views illustrating connector 2 for a flexible cable, which increases contact areas between FPC/FFC 15 and first and second terminals 22, 23 to achieve stable coupling, according to the related art. Connector 2 includes housing 24, first terminal 22 inserted into housing 24 in one direction to be electrically connected to FPC/FFC 15, second terminal 23 inserted in the opposite direction, and actuator 21 engaging first and second terminals 22, 23 and rotating to bring first and second terminals 22, 23 in contact with FPC/FFC 15. Since pressing part 25 of first terminal 22 is spaced distance L4 from pressing part 27 of second terminal 23, the contact areas between first and second terminals 22, 23 and FPC/FFC are increased to achieve stable coupling. However, center shaft 26 of first terminal 22 and center shaft 28 of second terminal 23, rotated by the rotation of actuator 21, are spaced distance L5 from each other. Accordingly, since the rotation centers of first and second terminals 22, 23 rotated by the rotation of actuator 21 are different from each other, contact pressures of first and second terminals 22, 23 are different from each other, thus deteriorating contact reliability. To compensate for deterioration of contact reliability due to the different lengths of terminals and the different positions of center shafts as described above, research has been carried out for adjusting the center axis of an actuator and a ratio of terminal connection parts to improve contact reliability. However, an FPC stop line to which FPC/FFC 15 is inserted is fixed at a predetermined axis, and a structure restricting a rotator of at actuator is required to give terminals having different lengths the same momentum, thus increasing the length of a product. Thus, it is difficult to miniaturize a product and reduce material costs. In addition, when an actuator is rotated past by a position where the maximum load is applied, and then arrives at a closed state, the reduction of contact pressure is still present.

### SUMMARY OF THE DISCLOSURE

The Present Disclosure is an effort to solve the above-described problems of the related art. An object of the Present Disclosure is to provide a connector for a flexible cable, which includes terminals having different contact points with the same contact pressure so as to secure contact reliability, which has the maximum contact pressure at a position where the operation of an actuator is completed, which prevents a precise reverse rotation sliding after the operation of the actuator is completed, and which has a slim structure.

In one embodiment, a connector for a flexible cable includes: a housing fixed on a printed circuit board and including a hole to which a FPC/FFC is inserted and coupled; even terminals inserted into an insertion space of the housing in a direct ion and arrayed in a plurality of lines; odd terminals disposed between the even terminals; and an actuator that is disposed on an opposite side to a side on which the FPC/FFC is inserted into the housing and includes a rotator that rotates to press and fix the FPC/FFC through the terminals, wherein a connection part of the even terminal connects a base part to a pressing part in a shape that is tilted in a direction, and a connection part of the odd terminal is disposed symmetrically with the tilted shape of the connection part of the even terminal, and the connection parts cross each other in an “X”-shape.

An operation part of the even terminal may include a rotation start section and a rotation end section, the rotation start section may include a deep recess to slightly engage with the rotator of the actuator, and a boundary protrusion may be disposed between the rotation start section and the rotation end section. An operation part of the odd terminal may include a rotation start section and a rotation end section, the rotation start section may include a deep recess to slightly engage with the rotator of the actuator, and a boundary protrusion may be disposed between the rotation start section and the rotation end section.

The rotation end section may include a recess that is shallower than the recess of the rotation start section, so as to have a maximum contact pressure at the rotation end section, and the rotation end section may include a recess that is shallower than the recess of the rotation start sect ion, so as to have a maximum contact pressure at the rotation end section. The rotator may be fixed by a stopper provided to an extension of the operation part of the even terminal, by a stopper provided to an extension of the base part, and by the boundary protrusion, so as to prevent contact pressure reduction caused by sliding after the rotator rotates to the rotation end section to have the maximum contact pressure.

According to the Present Disclosure, the connection parts of the first and second terminals alternately cross each other, and have the same rotation center to have the same contact pressure according to the same amount of rotation, and thus having the same contact reliability between the FPC/FFC and the terminals. Accordingly, it is unnecessary to move the center axis so as to miniaturize the connector. In addition, the recess of the rotation start section of the operation part is deep to facilitate the rotation of the actuator to about 90°, so that a worker can easily rotate the actuator to the closed state in a manufacturing process. Specifically, the maximum contact pressure is obtained at a position where the rotation of the actuator is finished, and the stopper prevents the contact pressure from being reduced after the rotation of the actuator is finished and thus maintaining the maximum contact pressure sustainedly.

### BRIEF DESCRIPTION OF THE DRAWINGS

FIGS. 1A-1C are schematic views illustrating a connector for a flexible cable and a graph illustrating reduction of a contact pressure according to rotation of an actuator, according to the related art;

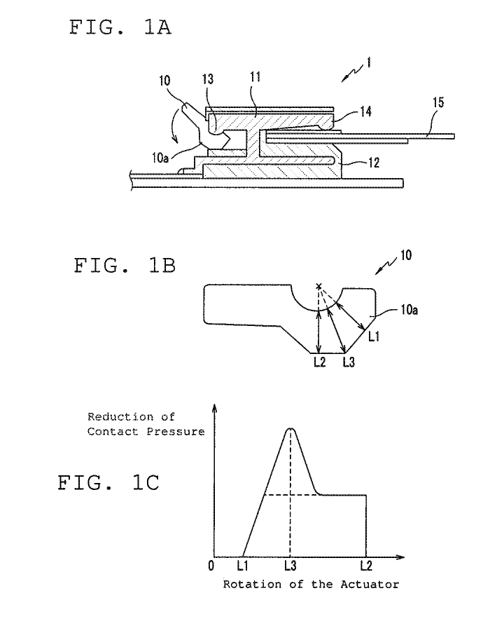

FIGS. 2A-2B are cross-sectional views illustrating contact distances from center axes of first and second terminals, according to the related art;

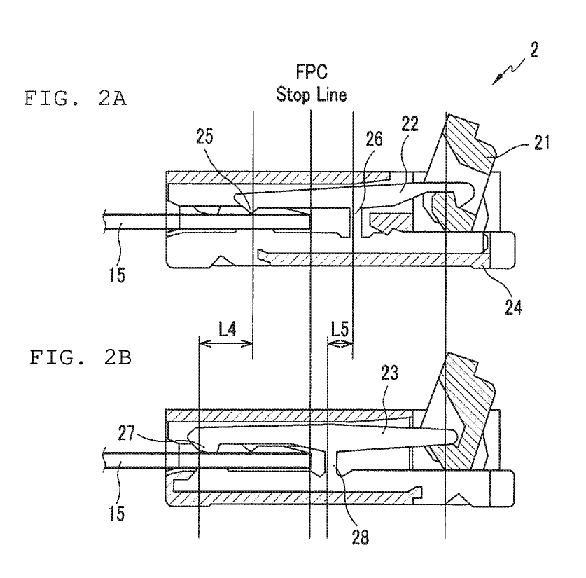

FIGS. 3A-3B are perspective and exploded perspective views that illustrate a connector for a flexible cable;

FIGS. 4A-4B are perspective and rear views that illustrate a housing of a connector for a flexible cable;

FIGS. 5A-5B are cross-sectional views illustrating a housing of a connector for a flexible cable, the housing including a part to which terminals are inserted;

FIGS. 6A-6B are a perspective view illustrating an even terminal of a connector for a flexible cable, and a cross-sectional view illustrating a housing coupled to an actuator;

FIGS. 7A-7B are a perspective view illustrating an odd terminal of a connector for a flexible cable, and a cross-sectional view illustrating a housing coupled to an actuator;

FIGS. 8A-8B are a perspective view and cross-sectional views that illustrate an actuator;

FIGS. 9A-9B are a cross-sectional view illustrating an even terminal and an odd terminal that cross each other in an “X”-shape when rotating a rotator, and a cross-sectional view illustrating a state where a FPC is inserted along a contact surface to the terminals;

FIGS. 10A-10B are side views illustrating operation parts of the terminals;

FIGS. 11A-11B are schematic views illustrating an operation where a rotation start section of an operation part engages with a rotator; and

FIGS. 12A-12B are schematic views illustrating an operation where a rotation end section of an operation part engages with a rotator.

### DESCRIPTION OF THE PREFERRED EMBODIMENTS

Hereinafter, exemplary embodiments of the Present Disclosure will now be described with reference to the accompanying Figures.

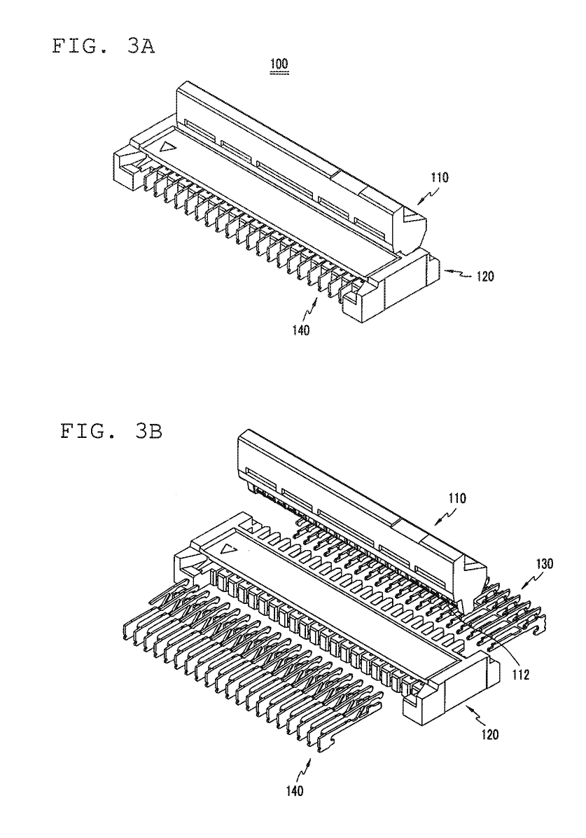

FIGS. 3A-3B are perspective and exploded perspective views illustrating a connector for a flexible cable. The connector includes housing 120—fixed on a printed circuit board and connected with FPC/FFC, even terminals 130—inserted in one direction into an insertion space of the housing 120 and arrayed in a plurality of lines, odd terminals 140—disposed between even terminals 130, and actuator 110—disposed on the opposite side on which the FPC/FFC is inserted into housing 120 and rotates to push and fix the FPC/FFC through terminals 130, 140.

First, the coupling directions of terminals 130, 140 will now be described. Even terminals 130 are inserted into housing 120 from the right side to the left side in the drawing, and odd terminals 140 are inserted into housing 120 from the left side to the right side. The coupling directions, however, are not limited thereto. For convenience in explanation, the basic structure of actuator 110 will now be described. Actuator 110 includes rotator 112 coupled to terminals 130, 140. Actuator 110 rotates to engage rotator 112 with terminals 130, 140, so that terminals 130, 140 fix and electrically contact the FPC/FFC.

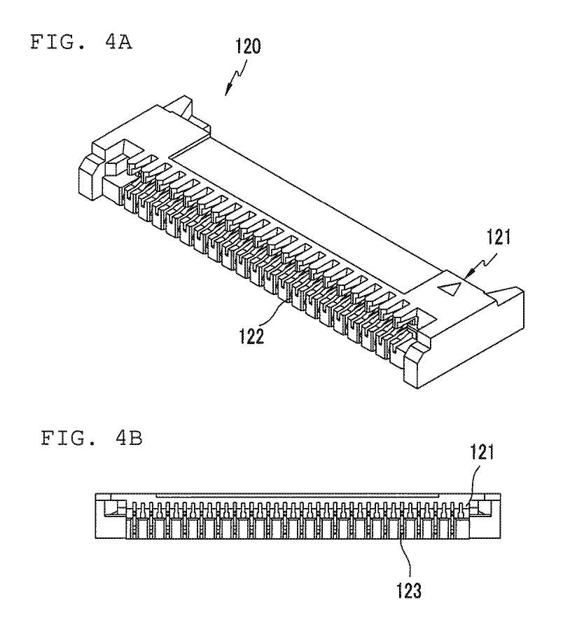

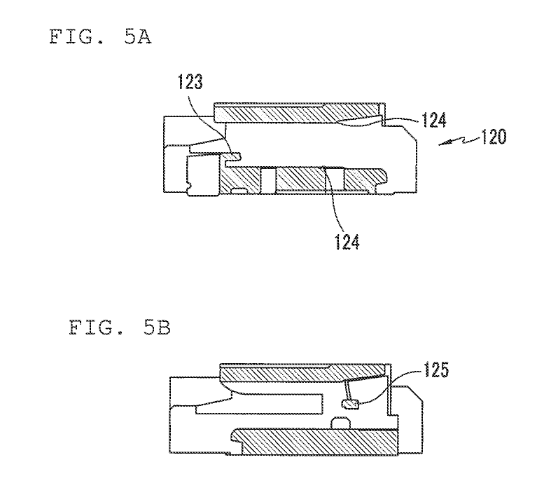

FIGS. 4-5 illustrate a perspective and rear view illustrating housing 120 of the connector for a flexible cable, and cross-sectional views illustrating parts to which terminals 130, 140 are inserted. Housing 120 is preferably formed of synthetic resin and generally has a flat hexahedron shape. Receiver slot 121, to which an end of the FPC/FFC is detachably attached, is disposed on the rear side thereof. Plurality of terminal insertion parts 122, 123, to which even terminals 130 and odd terminals 140 are respectively inserted and fixed, are arrayed alternately and symmetrically in the back-and-forth direction on the front and rear sides of housing 120.

The inside of the housing 120 to which terminals 130, 140 are inserted is provided with circular positioning holes 123, corresponding to the front parts of the inserted even terminals 130, and fixation holes 124. A part to which odd terminals 140 are inserted is provided with stoppers 125 that prevent the removal of odd terminals 140 after inserting the odd terminals 140.

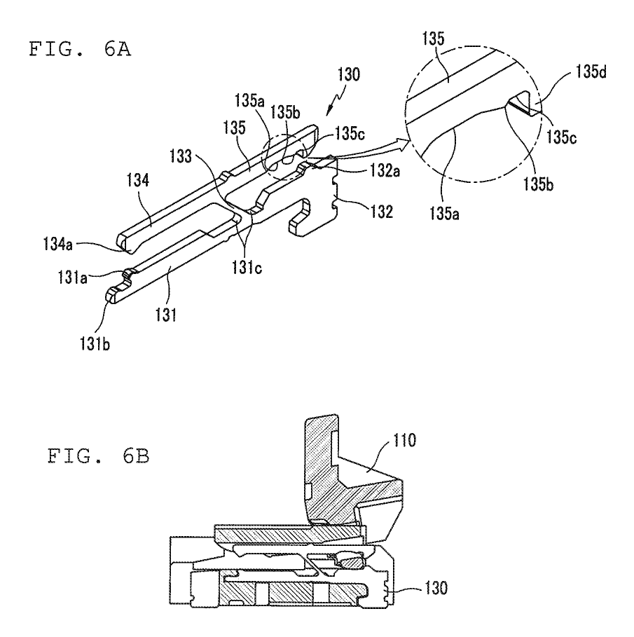

FIGS. 6A-6B are perspective views illustrating even terminals 130, and cross-sectional views illustrating housing 110 coupled to actuator 110. Even terminals 130 are spaced apart from housing 120 to fix actuator 110 and the FPC/FFC, and function as an electrical connection member. Even terminal 130 includes base part 131, pressing part 134—extending parallel to base part 131 and including pressing protrusion 134a in the lower end thereof, operation part 135—extending opposite to pressing part 134 and receiving a force for deforming connection part 133, wherein connection part 133 connects pressing part 134 to base part 131.

The front side (the left side of the drawing) of base part 131 is provided with circular element 131b so as to be placed on positioning holes 123 provided to the low surface of housing 120. The front upper end of base part 131 is provided with connection protrusion 131a connected electrically to the FPC/FFC. The rear side of base part 131 is provided with welding part 132—extended and welded to a printed circuit board (PCB) to fix terminal 130 to the PCB, and stopper 132a—preventing rotator 112 of actuator 110 from being rotated and removed from terminal 130 and maintaining the maximum contact pressure. Stopper 132a is configured to maintain the maximum contact pressure and may be trapezoid, which is not limited thereto.

Connection part 133 is tilted to the left side of the drawing from a vertical line that extends from base part 131 to form a “\”-shape. When operation part 135 is raised, connection part 133 is bent, so that pressing part 134, extending from operation part 135, is rotated counterclockwise to fix the FPC/FFC. Since a part where connection part 133 is connected to base part 131, and a part where connection part 133 is connected to pressing part 134, are thicker than the center of connection part 133, connection part 133 maximally receives an elastic force when deformed. Both sides of connection part 133 connected to base part 131 are provided with indentations 131c, preventing the concentration of stress due to a moment exerted to the portion between connection part 133 and base part 131 and efficiently dispersing a force when deformed.

The lower surface disposed in the end of pressing part 134 is provided with pressing protrusion 134a that is in contact with the FPC/FFC. Thus, when operation part 135 rotates pressing part 134 counter clockwise, the FPC/FFC is sufficiently in contact with connection protrusion 131a to have the maximum contact pressure between connection protrusion 131a of base part 131 and the FPC/FFC.

A section of operation part 135 engaging with rotator 112 of actuator 110 includes rotation start section 135a and rotation end section 135c. The rear side of operation part 135 is provided with stopper 135d. Operation part 135 extends in parallel to pressing part 134.

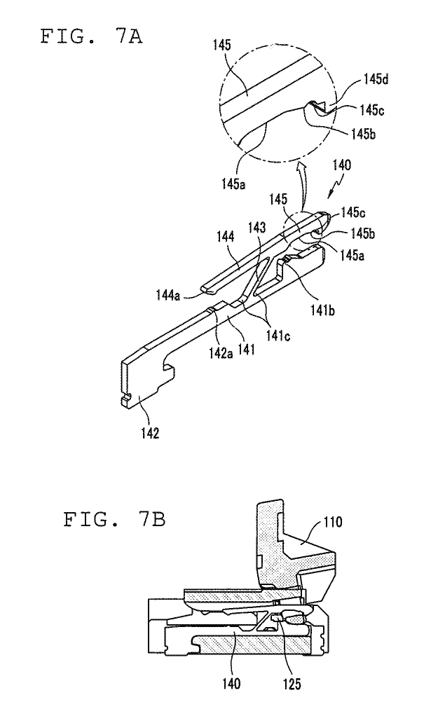

FIGS. 7A-7B are perspective views illustrating odd terminal 140, and cross-sectional views illustrating housing 120 coupled to actuator 110. Odd terminal 140 includes base part 141, pressing part 144—connected obliquely to base part 141 and including pressing protrusion 144a in its front end, connection part 143—in which a part where pressing part 144 is connected to connection part 143 is disposed on the right side of the drawing relative to a part where base part 141 is connected to connection part 143, so that connection part 143 symmetrically and obliquely crosses connection part 133 of even terminal 130, and an operation part 145 that extends in the opposite direction to pressing part 144 and receives a force for deforming connection part 143.

Base part 141 includes welding part 142 disposed on the front side thereof and coupled to the PCB, and connection protrusion part 142a coupled electrically to the FPC/FFC. A part connected to connection part 143 is provided with indentations 141c to prevent the concentration of stress due to a moment exerted to the portion between connection part 143 and base part 141 and to efficiently disperse a force when deformed. The rear side of base part 141 is provided with protrusion 141b that has a right-angled triangle shape, so that, when terminal 140 is inserted from the rear side (the left side of the drawing), terminal 140 is fitted elastically on stopper 125 of housing 120. Thus, an added fitting nail is not necessary, and the clockwise rotation of rotator 112 is prevented from pushing terminal 140 to the rear side (the left side of the drawing).

Connection part 143 is extended upward and tilted to the right side in a “/”-shape, and both connection part 143 and connection parts 133, inserted from the opposition direction alternately with odd terminal 140, form an “X”-shape in a side view. Further, pressing part 144 extends in a slightly curved line, not a horizontal line, and is shorter than pressing part 134.

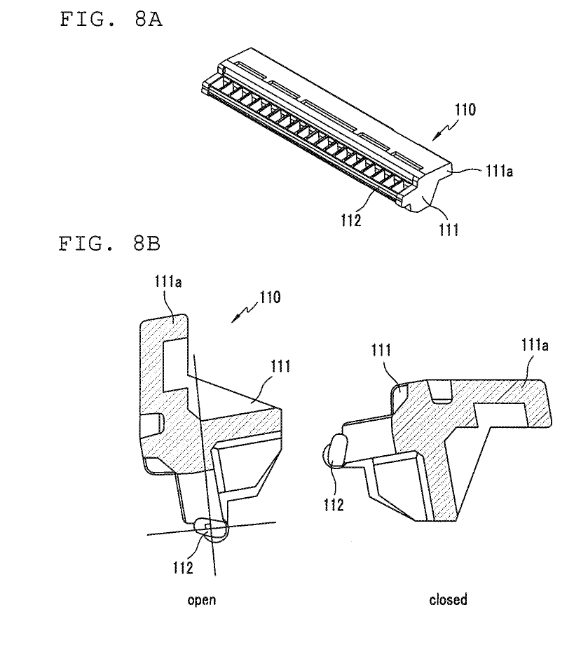

FIGS. 8A-8B are perspective and cross-sectional views that illustrate actuator 110. Actuator 110 is simultaneously engaged with both operation parts 135 of even terminals 130 and operation parts 145 of odd terminals 140. Actuator 110 rotates to lift operation parts 135, 145, so that the FPC/FFC is fixed to the rear side of housing 120. Actuator 110 includes rotator 112 that engages with operation parts 135, 145 to lift operation parts 135, 145 and fix the FPC/FFC, and body 111 that is molded integrally with rotator 112 to rotate rotator 112 with an external force.

Rotator 112 is an oval structure that forms an approximate 90° angle with body 111 as a vertical line. When actuator 110 is opened, rotator 112 is spaced apart from the operation parts 135, 145. When actuator 110 is rotated to be closed, rotator 112 rotates clockwise and engages with operation parts 135, 145 to lift the operation parts 135, 145. Body 111, molded integrally with rotator 112, rotates through the same angle as rotator 112, and includes handle 111a to facilitate to rotate actuator 110.

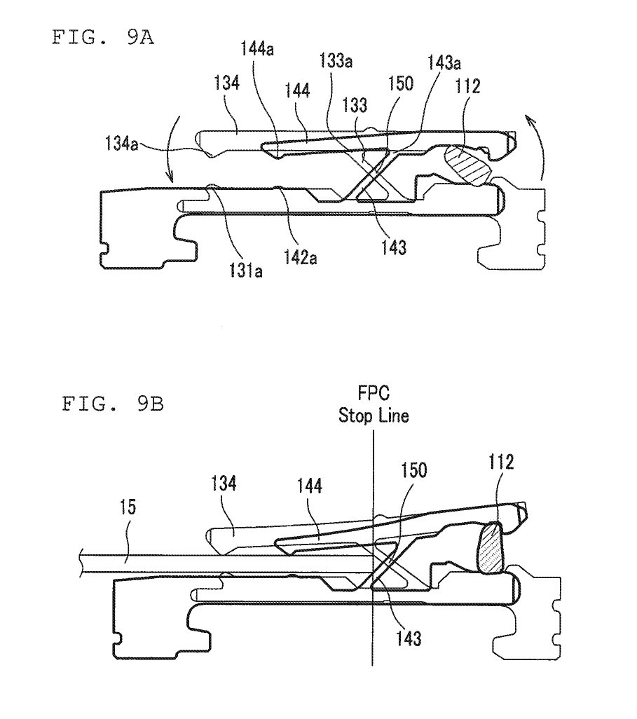

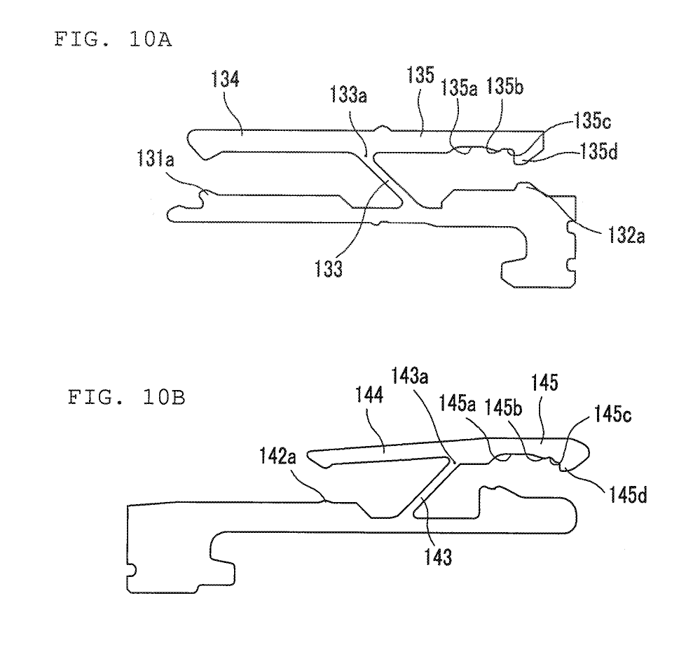

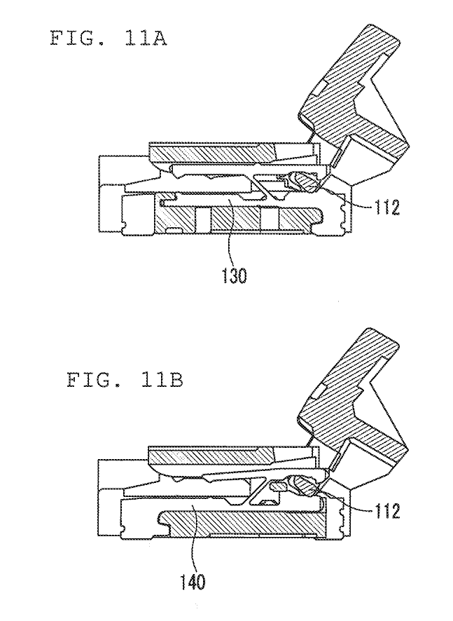

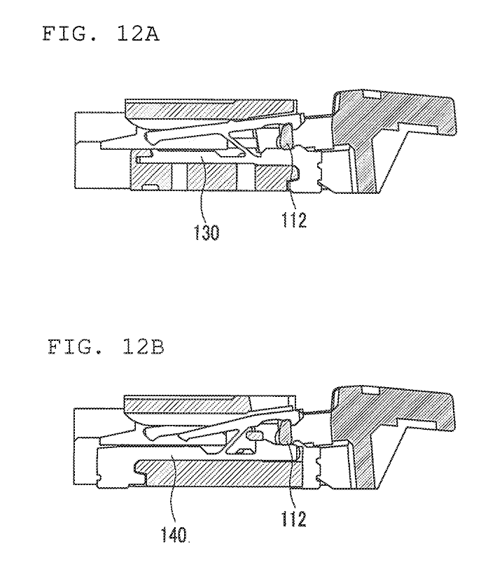

FIG. 9A is a cross-sectional view illustrating terminals 130, 140 crossing each other in an “X”-shape. FIG. 9B is a cross-sectional view illustrating a state where FPC/FFC 15 are inserted along a contact surface to terminals 130, 140 that are in the cross state. FIGS. 10A-10B are side views illustrating terminals 130, 140. FIGS. 11A-11B are schematic views illustrating an operation where start section 135a of operation part 135 engages with rotator 112. FIGS. 12A-12B are schematic views illustrating an operation where end section 135c of operation part 135 engages with rotator 112. The upper portion of connection part 133 of even terminal 130 is tilted in a curve line to the left side, and the upper portion of connection part 143 of odd terminal 140 is tilted in a curve line to the right side, above base part 141 and connection part 143, so that connection part 143 of odd terminal 140 disposed between even terminals 130 symmetrically crosses connection part 133 of even terminal 130.

Operation part 135 of even terminal 130 and the operation part 145 of odd terminal 140 engage alternately and continuously with rotator 112 of actuator 110, so as to simultaneously rotate according to the rotation of rotator 112. Thus, when rotator 112 rotates clockwise, operation parts 135, 145 engaging with rotator 112 rotate counterclockwise, so that pressing parts 134, 144 also rotate counterclockwise. In this case, since pressing part 134 of even terminal 130 is longer than pressing part 144 of odd terminal 140, pressing part 134 is, through the rotation of rotator 112, in contact with the rear side (the left side of the drawing) of FPC/FFC 15 relative to pressing part 144 of odd terminal 140, so that terminals 130, 140 are in contact with different points. Thus, the contact area of FPC/FFC 15 is increased to achieve the more stable coupling with FPC/FFC 15. In addition, FPC/FFC 15 can be patterned in zigzag shape to minimize the areas of both the FPC/FFC 15 and the connector.

While connection support base 133a of even terminal 130 is different from connection support base 143a, a rotation center of terminal 130 is the center of connection part 133, since connection part 133 of even terminal 130 is tilted in an “\”-, not “1”-shape. Thus, the rotation center of even terminal 130 is disposed on the right side of connection support base 133a. Since connection part 143 is also tilted in “/”-shape, the rotation center thereof is disposed on the left side of connection support base 143a. Thus, a cross point where connection parts 133, 143 cross each other is the rotation center of both the terminals 130, 140, so that the rotation centers are the same, although connection support bases 133a, 143a are different from each other.

As a result, since the rotation of rotator 112 applies the same torque to terminals 130, 140, terminals 130, 140 have the same momentum according to the rotation. In addition, since pressing protrusions 134a, 144a of pressing parts 134, 144 are parallel to each other at the same height from inserted FPC/FFC 15, rotator 112 rotates to apply the same force to pressing parts 134, 144 through the same distance, so that pressing protrusions 134a, 144a of terminals 130, 140 have the same contact force with FPC/FFC 15. Thus, contact variation is minimized, and contacting is performed with the same force, thereby improving the contact reliability between FPC/FFC 15 and terminals 130, 140. In addition, connection parts 133, 143 cross each other in an “X”-shape to maintain the same contact pressure without varying a ratio and positions of rotation axes, and FPC/FFC 15 can be inserted to arrive at the FPC stop line of terminals 130, 140 of connection parts 133, 143 along the direction in which FPC/FFC 15 is inserted as illustrated in FIG. 9B, so as to miniaturize a product including the connector.

Rotator 112 of actuator 110 is oval, and operation parts 135, 145 of terminals 130, 140 include rotation start sections 135a, 145a, end sections 135c, 145c, and protrusions 135b, 145b—between rotation start sections 135a, 145a and the rotation end sections 135c, 145c. Since operation parts 135, 145 have the same configuration, operation part 135 of even terminal 130 will be mainly described.

Rotation start section 135a is provided with a deep and gentle recess not to engage with rotator 112 when rotator 112 is rotated and lifted. Thus, even when actuator 110 is rotated to rotate and lift rotator 112 within approximately 45°, rotator 112 is not engaged with the recess of rotation start section 135a, so as to reduce a force required for rotating rotator 112. When rotator 112 is rotated over approximately 45°, rotator 112 is just slightly engaged with the recess of rotation start section 135a and rotated, but since the recess is deep, the engaging thereof is not strong, and thus the rotation is performed with a small force. Thus, actuator 110 is rotated with a small force until about 90° where rotator 112 meets protrusion 135b that will be described later.

When actuator 110 is rotated to arrive at about 90°, rotator 112 is in contact with boundary protrusion 135b of operation part 135. Since boundary protrusion 135b protrudes, relative to rotation start section 135a, when rotator 112 passes by boundary protrusion 135b, the elasticity of connection part 133 moves rotator 112 to rotation end section 135c, so that the contact pressure according to the movement from rotation start section 135a to rotation end section 135c is not continuous, but divided into two stages.

Since the recess of rotation end section 135c is shallower than the recess of rotation start section 135a, rotator 112 is intensively engaged with the recess of rotation end section 135c, so that the maximum upward force is applied to operation part 135, and thus the maximum downward force is applied to pressing part 134 extending from operation part 135. Accordingly, pressing protrusion 134a of pressing part 134 maximally presses FPC/FFC 15 to have the maximum contact pressure in rotation end sect ion 135c.

In addition, to prevent rotator 112 from rotating to rotation end section 135c of operation part 135 to have the maximum contact pressure slid back or forth so as to reduce the maximum contact pressure, operation part 135 and base part 131 of even terminal 130 are provided with stoppers 135d, 132a to prevent rotator 112 from further rotating to reduce the contact pressure, and boundary protrusion 135b prevents rotator 112 from being slid rearward and fixes rotator 112, so that rotator 112 is intensively in contact with the recess of the rotation end section 135c until intentionally releasing rotator 112, and thus maintaining the maximum contact pressure. Stopper 132a may be trapezoidal, and a stopper may be provided to odd terminal 140 to more firmly fix rotator 112.

Although the embodiments have been described with reference to a number of illustrative embodiments thereof, it should be understood that numerous other modifications, variations, replacements and additions can be devised by those skilled in the art, which will fall within the sprit and scope of the following claims.

What is claimed is:

1. A connector for a flexible cable, the connector comprising:
a housing fixed on a printed circuit board and including a hole to which a flexible printed circuit (FPC)/flexible flat cable (FFC) is inserted and coupled;
even terminals inserted into an insertion space of the housing in a direct ion and arrayed in a plurality of lines;
odd terminals disposed between the even terminals; and
an actuator that is disposed on an opposite side to a side on which the FPC/FFC is inserted into the housing and includes a rotator that rotates to press and fix the FPCIFFC through the terminals;
wherein a connection part of the even terminal connects a base part to a pressing part in a shape that is tilted in a direction, and a connection part of the odd terminal is disposed symmetrically with the tilted shape of the connection part of the even terminal, and the connection parts cross each other in an “X”-shape to have a same contact pressure.

2. The connector of claim 1, wherein:
an operation part of the even terminal comprises a rotation start sect ion and a rotation end sect ion, the rotation start section includes a deep recess to slightly engage with the rotator of the actuator, and a boundary protrusion is disposed between the rotation start section and the rotation end section; and
an operation part of the odd terminal comprises a rotation start section and a rotation end section, the rotation start sect ion includes a deep recess to slightly engage with the rotator of the actuator, and a boundary protrusion is disposed between the rotation start section and the rotation end section.

3. The connector of claim 2, wherein:
the rotation end sect ion comprises a recess that is shallower than the recess of the rotation start sect ion, so as to have a maximum contact pressure at the rotation end section, and the rotation end section comprises a recess that is shallower than the recess of the rotation start section, so as to have a maximum contact pressure at the rotation end section; and
the rotator is fixed by a stopper provided to an extension of the operation part of the even terminal, by a stopper provided to an extension of the base part, and by the boundary protrusion, so as to prevent contact pressure reduction caused by sliding after the rotator rotates to the rotation end section to have the maximum contact pressure.
